(19) United States
(12) Patent Application Publication
(10) Pub. No.: US 2013/0227382 A1
(43) Pub. Date: Aug. 29, 2013

(54) Method and system for extracting requirements from narratives

(71) Applicant: Naoufel Boulila, Munchen (DE)

(72) Inventor: Naoufel Boulila, Munchen (DE)

(21) Appl. No.: 13/407,799

(22) Filed: Feb. 29, 2012

(51) Int. Cl. G06F 17/20

(52) U.S. Cl. 715/201

(57) ABSTRACT

The invention provides for methods, devices and systems for extracting requirements from narratives, in particular to methods of using stories told individually to extract technical requirements. One method for extracting requirements from a narrative comprises gathering a plurality of sub-stories from stakeholders, combining the plurality of sub-stories into a narrative, extracting information components from the narrative, mapping the extracted information components to story elements, mapping the identified story elements to requirement artifacts, and building at least requirements document from the mapped requirement artifacts.

### FIELD OF THE INVENTION

The present invention relates to methods, devices and systems for extracting requirements from narratives, in particular to methods of using stories told individually to extract technical requirements.

### BACKGROUND OF THE INVENTION

Elicitation of requirements, for example for software projects, is an important task in trying to guarantee the successful implementation of projects. Studies conducted have shown that about 40% of all the defects in software projects are due to incorrectly recorded requirements.

The document Gall, M.; Bruegge, B.; Berenbach, B.: “Towards a framework for real time requirements elicitation”, First International Workshop on Multimedia Requirements Engineering, Minneapolis, 2006 discloses methods for eliciting clear, complete and correct requirements in requirements engineering. However, these methods still prove to be challenging and difficult to implement. Most of the existing approaches do not focus on making users tell what they feel like telling, but instead constrain users with a particular process flow, such as interview-based and questionnaire-based processes.

### SUMMARY OF THE INVENTION

It is one idea of the present invention to use storytelling as a systematic tool to elicit, extract, and document requirements. The elicitation phase is to be a rich activity that allows the requirements engineer to obtain much more of raw information and knowledge about the requirements and the stakeholders' needs for a particular to-be-developed system or improving an existing system. The proposed solution includes a framework and a process defining how to acquire the necessary knowledge from different stakeholders and to identify new stakeholders relevant for determining the stakeholders' needs. The framework uses techniques developed based on the combination of natural English language processing and English literature of storytelling elements and knowledge transformation mechanisms.

In a first aspect, the invention provides a method for extracting requirements from a narrative, the method comprising gathering a plurality of sub-stories from stakeholders, combining the plurality of sub-stories into a narrative, extracting information components from the narrative, mapping the extracted information components to story elements, mapping the identified story elements to requirement artifacts, and building at least requirements document from the mapped requirement artifacts. The granularity of the collected data and extracted information defines the type of the requirements document to be generated. High-level extracted information will be mapped to business requirements documents. More specific information about users will be mapped into user requirements documents. More detailed information will be mapped to system requirements documents including, but not limited to, system functionalities and behavior with use cases, scenarios, sequence-diagram models, activity-diagrams models.

In one embodiment of the first aspect, the plurality of substories comprise one or more of the group of textual documents, voice recordings, screen shots, images and conference protocol transcripts.

In another embodiment of the first aspect, the story elements comprise one or more of the group of conflict, theme, setting, plot, characters and point of view.

In yet another embodiment of the first aspect, the requirement artifacts comprise one or more of the group of project constraints, project goals, project context, project activities, project agents and project requirement levels.

In a second aspect, the invention provides a method for extracting requirements from a narrative, the method comprising gathering a first plurality of sub-stories from known, i.e. first stakeholders, extracting story elements from each of the first plurality of sub-stories, combining the extracted story elements into a main narrative, mapping the extracted story elements of the main narrative to requirement artifacts, and building at least one requirements document from the mapped requirement artifacts.

In one embodiment of the second aspect, the method further comprises analyzing the first plurality of sub-stories from the known, i.e. first stakeholders, depending on the analyzed sub-stories, identifying new, i.e. second stakeholders, and gathering a second plurality of sub-stories from the second stakeholders. As a further embodiment of the second aspect, the method further comprises analyzing the second plurality of sub-stories from the second stakeholders, extracting further story elements from each of the second plurality of substories, and combining the extracted further story elements into the main narrative.

In a third aspect, the invention provides a computer program product comprising a computer-readable medium which stores computer-readable instructions for performing a method of one of the first and second aspects on a computer.

In a fourth aspect, the invention provides a system for extracting requirements from a narrative, the system comprising a gathering module configured to gather a plurality of substories from stakeholders, a combining module which is operatively coupled to the gathering module and which is configured to combine the plurality of sub-stories into a narrative, an extraction module which is operatively coupled to the combining module and which is configured to extract information components from the narrative, a mapping module which is operatively coupled to the extraction module and which is configured to map the extracted information components to story elements and to map the identified story elements to requirement artifacts, and a building module which is operatively coupled to the mapping module and which is configured to build at least one requirements document from the mapped requirement artifacts.

In one embodiment of the fourth aspect, the plurality of substories comprise one or more of the group of textual documents, voice recordings, screen shots, images and conference protocol transcripts.

In another embodiment of the fourth aspect, the story elements comprise one or more of the group of conflict, theme, setting, plot, characters and point of view.

In yet another embodiment of the fourth aspect, the requirement artifacts comprise one or more of the group of project constraints, project goals, project context, project activities, project agents and project requirement levels.

Advantageously, the methods, devices and systems of the various aspects of the invention come natural to human beings, encourage sharing values, develop trust and commitment, generate emotional connections, refrain from restraining stakeholders in their articulation and enable the transfer of raw knowledge.

### BRIEF DESCRIPTION OF THE DRAWINGS

The accompanying drawings are included to provide a further understanding of the present invention and are incorporated in and constitute a part of this specification. The drawings illustrate the embodiments of the present invention and together with the description serve to explain the principles of the invention. Other embodiments of the present invention and many of the intended advantages of the present invention will be readily appreciated as they become better understood by reference to the following detailed description. The elements of the drawings are not necessarily to scale relative to each other. Like reference numerals designate corresponding similar parts.

FIG. 1 schematically illustrates an embodiment of a processing environment for a system for extracting requirements from narratives.

FIG. 2 schematically illustrates an embodiment of a flow diagram for a method for extracting requirements from narratives.

FIG. 3 schematically illustrates a diagram of elements of a story.

FIG. 4 schematically illustrates an embodiment of a method for extracting requirements from narratives.

FIG. 5 schematically illustrates a further embodiment of a method for extracting requirements from narratives.

FIG. 6 schematically illustrates an embodiment of a system operable to extract requirements from narratives.

FIG. 7 schematically illustrates another embodiment of a system operable to extract requirements from narratives.

### DETAILED DESCRIPTION OF THE EMBODIMENTS

Although specific embodiments have been illustrated and described herein, it will be appreciated by those of ordinary skill in the art that a variety of alternate and/or equivalent implementations may be substituted for the specific embodiments shown and described without departing from the scope of the present invention. Generally, this application is intended to cover any adaptations or variations of the specific embodiments discussed herein.

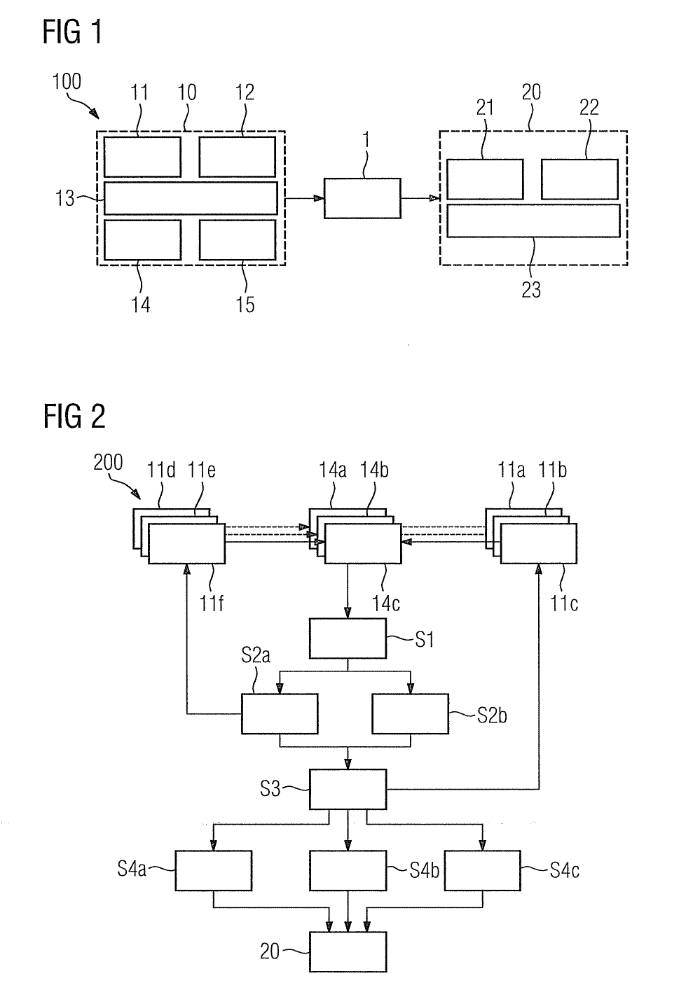

FIG. 1 illustrates a processing environment 100 for a system 1 for extracting requirements from narratives 10. The system 1 may comprise a framework that is configured to acquire necessary knowledge from different stakeholders' stories. In order to do so, the system 1 may use techniques that are based on the combination of English literature of story telling elements and knowledge transformation mechanisms.

Story telling as a technique may be used for knowledge management, with stories being a tool to conserve knowledge in condensed form. In order to extract this knowledge from stories it is necessary to first identify information components in a story, liken these identified information components with structural story elements and find a mapping relationship between the story elements and structural elements of requirement engineering, so-called requirements artifacts.

When gathering information for requirements engineers to analyze and group up, it is important to gather this information from users in a way that comes naturally to them. Story telling is a logical process that users intuitively understand since it is closely related to how people ordinarily learn and communicate. Relating a story to what a user needs is an improvement to the information gathering process since it does not artificially constrain the user in what he wants to communicate. Therefore, with stories the likelihood of losing details or relaying them in a wrong context is considerably lessened.

A narrative 10 in the context of English literature comprises an agent 11, also called “narrator”, who uses a narrative medium 12 through which the agent 11 communicates a story 14.

The story 14 is usually a fabula 13 that is presented in a certain manner, wherein a fabula 13 can be seen as a series of events caused by actors of the story 14. The fabula 13 may in particular be a series of events concatenated in chronology and causation. When combining the fabula 13 with a specific syuzhet, the outcome may be a specific story 14.

A special case of a story 14 is a user story 15 which is a very detailed source for the definition of a requirement, containing just enough information that a developer or requirements engineer may produce a reasonable estimate of the effort to implement it. FIG. 4 shows an exemplary embodiment of a method 400 for extracting requirements from narratives. A user 11 or agent 11 may have certain informal user needs 111 that relate to a certain problem or topic within a specific project environment. The user 11 may have a deeper knowledge of his or her needs and may know how to express these needs using a template such as a user story 15. The transformation from a user story 15 to a requirements scenario 16 and, in turn, to a specific use case 17 may be straightforward.

FIG. 2 schematically illustrates a flow diagram 200 for a method for extracting requirements from narratives. The method may in particular be performed by a system such as the system 1 as exemplarily shown in FIG. 1. In a first step S1, a plurality of sub-stories 14a, 14b, 14c may be gathered from first stakeholders 11a, 11b, 11c. The stakeholders 11a, 11b, 11c may be narrators or agents 11 in the sense of FIG. 1 and deliver their respective sub-stories 14a, 14b, 14c as textual document, voice recording, screen shot, image or conference protocol transcript. Each stakeholder 11a, 11b, 11c may provide a respective sub-story 14a, 14b, 14c about the current situation in an enterprise, the future system or anything relevant to the topic. The sub-stories 14a, 14b, 14c reflect the stakeholders' 11a, 11b, 11c point of view and reflect his or her understanding of the situation and the possible problems.

The system 1 may analyze all the sub-stories 14a, 14b, 14c and, depending on the analyzed sub-stories, identify new stakeholders 11d, 11e, 11f that have not yet been considered so far in a step S2a. These stakeholders 11d, 11e, 11f may then be prompted to gather additional sub-stories from the newly identified stakeholders 11d, 11e, 11f, for example in a further story telling session. These newly gathered substories may in consequence be analyzed by the system 1 again, until no more new stakeholders can be identified. This may for example be done by analyzing the newly gathered substories from the newly identified stakeholders, extracting further story elements from each of the newly gathered substories, and combining the extracted further story elements into the main narrative, as explained later on in context with step S3.

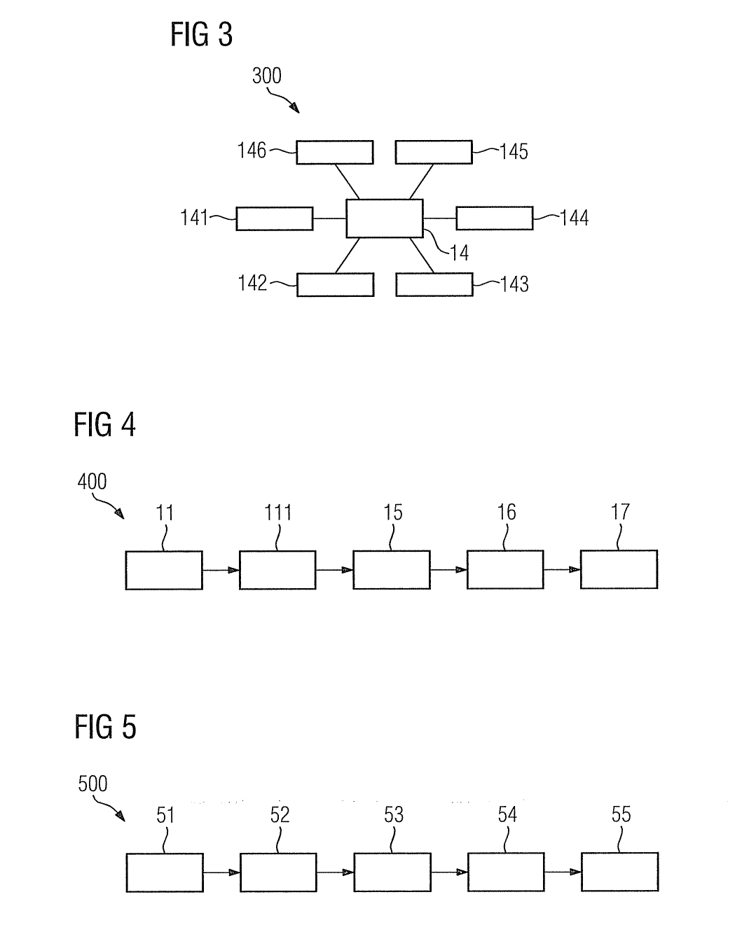

From each of the plurality of sub-stories, story elements may be extracted in a step S2b. These are the elements that correspond to a story as known in English literature. FIG. 3 schematically illustrates a diagram 300 of elements of a story 14. The story 14 may for example include a conflict 141, a theme 142, a setting 143, a plot 144, characters 145 and a point of view 146.

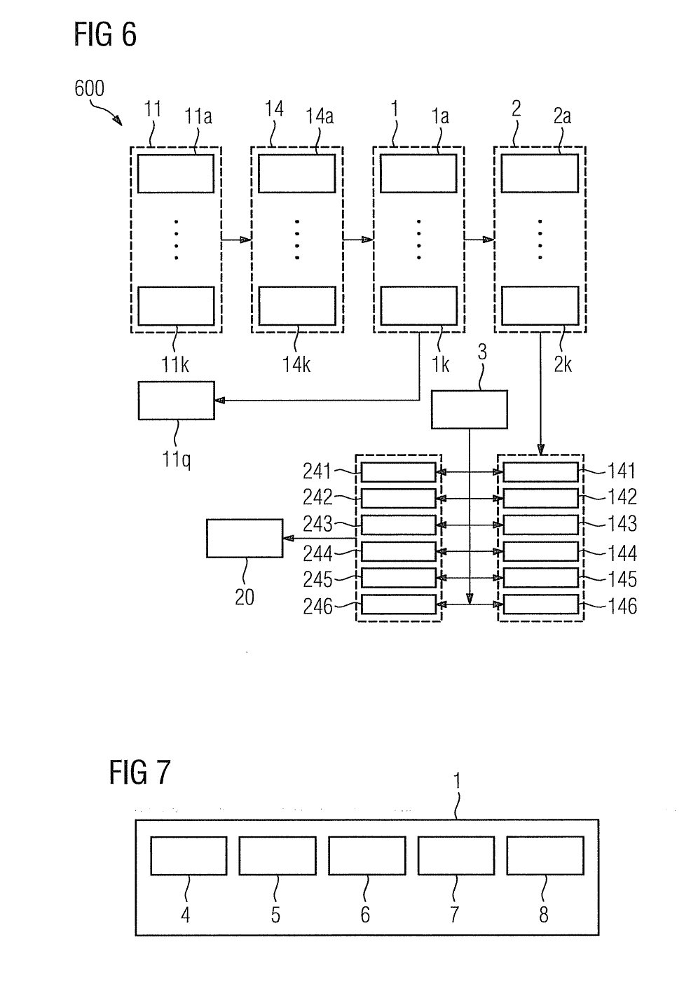

In a step S3, the extracted story elements may be combined into a main narrative that comprises a collection of all substory elements that have been extracted in step S2b. This main narrative serves as a starting point for the creation of a requirement document. The main narrative may include contradicting input from the different sub-stories. Therefore, a conflict resolution mechanism may be included in the transformation engine which basically ensures a requirements document free from conflicts and contradictions. For example, in a step S4a, the extracted story elements of the main narrative may be mapped to requirement artifacts. How story elements may be mapped to requirement artifacts will be explained in conjunction with FIG. 6.

In a step S4b, requirement scenarios may be built from the extracted story elements. These scenarios include relevant scenarios for further requirement developments in order to validate the stories and/or to validate the understanding of the stakeholders' 11a, 11b, 11c, 11d, 11e, 11f needs. These scenarios may in a step S4c for example be translated into use cases, and, in turn, in requirement models which may be useful for further requirement developments and understanding as well as a starting point for requirement engineers to design architectural elements for a possible solution.

Finally, at least one requirements document 20 may be built from the mapped requirement artifacts and possibly the requirement scenarios and/or requirement models, as created in steps S4a, S4b and S4c.

FIG. 5 schematically illustrates a further method 500 for extracting requirements from narratives. The method 500 may also be performed using a system for extracting requirements from narratives such as the system 1 in FIG. 1.

The method 500 may comprise in a step 51 gathering a plurality of sub-stories from stakeholders, in a step 52 combining the plurality of sub-stories into a narrative, in a step 53 extracting information components from the narrative, in a step 54 mapping the extracted information components to story elements and mapping the identified story elements to requirement artifacts, and in a step 55 building at least one requirements document from the mapped requirement artifacts.

The plurality of sub-stories may comprise one or more of the group of textual documents, voice recordings, screen shots, images and conference protocol transcripts. The story elements may comprise one or more of the group of conflict, theme, setting, plot, characters and point of view, as explained in conjunction with FIG. 3. Finally, the requirement artifacts may comprise one or more of the group of project constraints, project goals, project context, project activities, project agents and project requirement levels, as will be explained in conjunction with FIG. 6.

Each of the methods exemplarily outlined in the illustrations of FIGS. 2 and 5 may be embodied in a computer program product which comprises a computer-readable medium which stores computer-readable instructions for performing a method of one of the embodiments on a computer. Specifically, the computer-readable instructions may be intended to define the processes and frameworks of the system 1 of FIG. 1.

FIG. 6 schematically illustrates a processing environment 600 with a system 1 that is operable to extract requirements from narratives. The system 1 itself is shown in more detail in FIG. 7. The system 1 may comprise a gathering module 4, a combining module 5, an extraction module 6, a mapping module 7 and a building module 8.

A plurality of sub-stories 14a to 14k are gathered from stakeholders 11a to 11k, which each tell or otherwise provide their respective sub-story 14a to 14k. The plurality of substories 14a to 14k may for example comprise textual documents, voice recordings, screen shots, images or conference protocol transcripts. The plurality of sub-stories 14a to 14k are input to the system 1, where the gathering module 4 may be configured to gather the plurality of sub-stories 14a to 14k from the stakeholders 11a to 11k. The combining module 5 which is operatively coupled to the gathering module 4 may be configured to combine the plurality of sub-stories 14a to 14k into a narrative. This may be done by analyzing the plurality of sub-stories 14a to 14k in system components 1a to 1k of the system.

In order to complete the set of sub-stories, additional stakeholders 11q may be identified in the system 1 in order to prompt these stakeholders 11q to provide more sub-stories that are incorporated into the main narrative as explained above.

The extraction module 6 which is operatively coupled to the combining module 5 may be configured to extract information components 2a to 2k from the narrative. These information components 2a to 2k may be used to identify story elements 141, 142, 143, 144, 145 and 146, as explained in conjunction with FIG. 3. The mapping module 7 which is operatively coupled to the extraction module 6 may be configured to map the extracted information components 2a to 2k to the respective story elements 141, 142, 143, 144, 145 and 146 and, in turn, to map the identified story elements 141, 142, 143, 144, 145 and 146 to respective requirement artifacts 241, 242, 243, 244, 245 and 246. This may for example be done by using a mapping table 3 where all the relevant mapping relationships may be stored.

The mapping table 3 may for example map the conflict 141 to the basic problem 241 to solve in the requirements process. Such a conflict may for example exist between stakeholders' needs or between technical constraints and stakeholders' needs. The theme 142 may be mapped to the central concept 242 underlying the solution in the requirements document 20. This solution may in requirements engineering be the project goal. The setting 143, that is the place and time of the story 14, may be mapped to broader context 243 of the problem being solved. This may for example include information about the technological environment, business conditions, industry conditions or economic conditions. The plot 144, that is the order of events and the outcome of each event in the story 14, may be mapped to a series of processes 244 that occur in the current or the future system. The characters 145, that is the entities acting within the course of events in the story 14, may be mapped to people, groups of people, machines or programs that take part in the solution according to the requirements model. The point of view 146 may finally be mapped to a view-based system 246 that provides an overview over everything that happens and what everyone involved in the project needs.

Finally, the requirement artifacts 241, 242, 243, 244, 245 and 246 are used in the building module 8 which is operatively coupled to the mapping module 7 to build at least one requirements document 20 from the mapped requirement artifacts 241, 242, 243, 244, 245 and 246. The requirements document 20 may for example be a structured text, a flow diagram, a structured requirements model or a list of recommendations.

One or more embodiments of devices and systems according to the invention may include a general purpose computing device in the form of a computer, for example a personal computer, a workstation, a server or a similar device, including for example, but not exclusively one or more processing units, a system memory, and a system bus that operatively couples various system components including the system memory to the processing units. There may be only one or there may be more than one processing unit, such that the processor of the computer comprises a single central processing unit, or a plurality of processing units, commonly referred to as a multiprocessor or parallel-processor environment. In various embodiments, which may comprise some but not all of the foregoing embodiments, the computer may be a conventional computer, a distributed computer, or any other type of computer.

The system bus may be any of several types of bus structures including a memory bus or memory controller, a peripheral bus, and a local bus using any of a variety of bus architectures. The system memory may also be referred to as simply the memory, and, in some but not necessarily all embodiments, includes read-only memory and/or random-access memory. A basic input/output system program, containing the basic routines that help to transfer information between elements within the computer, such as during start-up, may be stored in a read-only memory. The computer may further include a hard disk drive for reading from and writing to a hard disk, a magnetic disk drive for reading from or writing to a removable magnetic disk, and/or an optical disk drive for reading from or writing to a removable optical disk such as a CD ROM or other optical media.

The hard disk drive, magnetic disk drive, and optical disk drive may couple with a hard disk drive interface, a magnetic disk drive interface, and an optical disk drive interface, respectively. The drives and their associated computer-readable media provide non-volatile storage of computer-readable instructions, data structures, program modules and other data for the computer. It should be appreciated by one skilled in the art that any type of computer-readable media which is able to store data that is accessible by a computer, such as magnetic cassettes, flash memory cards, digital video disks, random access memories, read only memories, universal serial bus flash memory sticks, and the like, may be used in the exemplary systems.

A plurality of program modules may be stored on the hard disk, magnetic disk, optical disk, read-only memory, and/or random access memory, including an operating system, one or more application programs, other program modules, and program data.

A user may enter commands and information into the computer through input devices such as a keyboard and a pointing device. Other input devices may include a microphone, a joystick, a game pad, a scanner, or the like. These other input devices are often connected to the processing units through a serial port interface that is coupled to the system bus, but can be connected by other interfaces, such as a parallel port, game port, or a universal serial bus port. A monitor or other type of display device may also be connected to the system bus via an interface, such as a video adapter. The monitor may be able display a graphical user interface for the user. In addition to the monitor, the computer may be coupled to other peripheral output devices, such as speakers, printers, and other not explicitly mentioned devices.

In the foregoing detailed description, various features are grouped together in one or more examples or examples for the purpose of streamlining the disclosure. This method of disclosure is not to be interpreted as reflecting an intention that the claimed examples of the invention require more features than are expressly recited in each claim. Rather, as the following claims reflect, inventive subject matter lies in less than all features of a single disclosed example. Thus the following claims are hereby incorporated into the detailed description as examples of the invention, with each claim standing on its own as a separate example. It is understood that the above description is intended to be illustrative, and not restrictive. It is intended to cover all alternatives, modifications and equivalents as may be included within the scope of the invention as defined in the appended claims. Many other examples will be apparent to one skilled in the art upon reviewing the above specification. The scope of the invention should, therefore, be determined with reference to the appended claims, along with the full scope of equivalents to which such claims are entitled. Specific nomenclature used in the foregoing specification is used to provide a thorough understanding of the invention. However, it will be apparent to one skilled in the art in light of the specification provided herein that the specific details are not required in order to practice the invention. Thus, the foregoing descriptions of specific embodiments of the present invention are presented for purposes of illustration and description. They are not intended to be exhaustive or to limit the invention to the precise forms disclosed; obviously many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated. In the appended claims and throughout the specification, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on or to establish a certain ranking of importance of their objects.

The invention provides for methods, devices and systems for extracting requirements from narratives, in particular to methods of using stories told individually to extract technical requirements. One method for extracting requirements from a narrative comprises gathering a plurality of sub-stories from stakeholders, combining the plurality of sub-stories into a narrative, extracting information components from the narrative, mapping the extracted information components to story elements, mapping the identified story elements to requirement artifacts, and building at least requirements document from the mapped requirement artifacts.

### LIST OF REFERENCE SIGNS

1 System

1a System component

1k System component

2 Information components

2a Information component

2k Information component

3 Mapping table

4 Gathering module

5 Combining module

6 Extraction module

7 Mapping module

8 Building module

10 Narrative

11 Agent

11a Stakeholder

11b Stakeholder

11c Stakeholder

11d Stakeholder

11e Stakeholder

11f Stakeholder

11k Stakeholder

11q Stakeholder

12 Narrative medium

13 Fabula

14 Story

14a Sub-story

14b Sub-story

14c Sub-story

14k Sub-story

15 Agent story

16 Scenario

17 Use case

20 Requirements document

21 Structured text

22 Requirements diagram

23 Requirements model

51 Method step

52 Method step

53 Method step

54 Method step

55 Method step

100 Processing environment

111 Agent needs

141 Conflict

142 Theme

143 Setting

144 Plot

145 Characters

146 Point of view

200 Flow diagram

241 Constraints

242 Project goal

243 Context

244 Activities

245 Actors

246 Requirement levels

300 Story elements

400 Use case transformation

500 Method

600 Processing environment

S1 Method step

S2a Method step

S2b Method step

S3 Method step

S4a Method step

S4b Method step

S4c Method step

We claim:

1. A method for extracting requirements from a narrative, the method comprising:
gathering a plurality of sub-stories from stakeholders;
combining the plurality of sub-stories into a narrative;
extracting information components from the narrative;
mapping the extracted information components to story elements;
mapping the identified story elements to requirement artifacts; and
building at least one requirements document from the mapped requirement artifacts.

2. The method of claim 1, wherein the plurality of substories comprise one or more of the group of textual documents, voice recordings, screen shots, images and conference protocol transcripts.

3. The method of claim 1, wherein the story elements comprise one or more of the group of conflict, theme, setting, plot, characters and point of view.

4. The method of claim 1, wherein the requirement artifacts comprise one or more of the group of project constraints, project goals, project context, project activities, project agents and project requirement levels.

5. A method for extracting requirements from a narrative, the method comprising:
gathering a first plurality of sub-stories from first stakeholders;
extracting story elements from each of the first plurality of sub-stories;
combining the extracted story elements into a main narrative;
mapping the extracted story elements of the main narrative to requirement artifacts; and
building at least one requirements document from the mapped requirement artifacts.

6. The method of claim 5, further comprising:
analyzing the first plurality of sub-stories from the first stakeholders;
depending on the analyzed sub-stories, identifying second stakeholders; and
gathering a second plurality of sub-stories from the second stakeholders.

7. The method of claim 6, further comprising:
analyzing the second plurality of sub-stories from the second stakeholders;
extracting further story elements from each of the second plurality of sub-stories; and
combining the extracted further story elements into the main narrative.

8. A computer program product comprising a computer-readable medium which stores computer-readable instructions for performing a method of one of the claims 1 to 7 on a computer.

9. A system for extracting requirements from a narrative, the system comprising:
a gathering module configured to gather a plurality of sub-stories from stakeholders;
a combining module which is operatively coupled to the gathering module and which is configured to combine the plurality of sub-stories into a narrative;
an extraction module which is operatively coupled to the combining module and which is configured to extract information components from the narrative;
a mapping module which is operatively coupled to the extraction module and which is configured to map the extracted information components to story elements and to map the identified story elements to requirement artifacts; and
a building module which is operatively coupled to the mapping module and which is configured to build at least one requirements document from the mapped requirement artifacts.

10. The system of claim 9, wherein the plurality of substories comprise one or more of the group of textual documents, voice recordings, screen shots, images and conference protocol transcripts.

11. The system of claim 9, wherein the story elements comprise one or more of the group of conflict, theme, setting, plot, characters and point of view.

12. The system of claim 9, wherein the requirement artifacts comprise one or more of the group of project constraints, project goals, project context, project activities, project agents and project requirement levels.
